(19) United States
(12) Patent Application Publication
(10) Pub. No.: US 2023/0245011 A1
(43) Pub. Date: Aug. 3, 2023

(54) COGNITIVE INCIDENT TRIAGE (CIT) WITH MACHINE LEARNING

(71) Applicant: International Business Machines Corporation, Armonk, NY (US)

(72) Inventors: Pranshu Tiwari, Delhi (IN); Swarnalata Patel, MORRISVILLE, NC (US); Harish Bharti, Pune (IN); Manohar Chintala, CARY, NC (US)

(21) Appl. No.: 17/648,186

(22) Filed: Jan. 18, 2022

(51) Int. Cl. G06Q 10/06; G06F 40/30

(52) U.S. Cl. CPC G06Q 10/063112; G06F 40/30

(57) ABSTRACT

Disclosed are techniques for training and utilizing a machine learning model for automatically accelerating technical incident triage. A historical dataset is combined from a plurality of sources corresponding to historical technical incidences and how they were resolved, including what persons or responders were involved in responding to the incident. This historical dataset is processed for input into a machine learning model which is trained to output a ranking of historical incidences based on similarity to an input incident. Machine logic then automatically selects a responder for the incident based on which available responders previously resolved the ranked historical incidences, selecting responders from the most similar historical incidences if they are available, and communicating information from the ranked historical incidences to assist in diagnosing and resolving the input incident.

### BACKGROUND

The present invention relates generally to the field of information technology incident response management systems, and more particularly to machine learning based technical incident response management systems.

Machine learning (ML) refers to the study of computer algorithms which can improve automatically through experience and through the use of data. It is viewed as a part of the field of artificial intelligence. Machine learning algorithms construct a model based on sample data, known as “training data” in order to make predictions or decisions without being explicitly programmed to do so. Machine learning algorithms are leveraged in a wide variety of applications, such as in medicine, email filtering, speech recognition, and computer vision, where it is difficult or unfeasible to develop conventional algorithms to complete the needed tasks.

The principal components of a collection of points in a real coordinate space are a sequence of p unit vectors, where the i-th vector is the direction of a line that best fits the data while being orthogonal to the first i – 1 vectors. Here, the definition of a best-fitting line is one that minimizes the average squared distance from the points to the line. These directions add up to an orthonormal basis where different individual dimensions of the data are linearly uncorrelated. Principal component analysis (PCA) is defined as the process of computing the principal components and utilizing them to perform a change of basis on the data, sometimes using only the first few principal components and ignoring the rest.

In statistics, a mixture model refers to a probabilistic model for representing the presence of subpopulations within an overall population, without requiring that an observed data set should identify the sub-population to which an individual observation belongs. Formally a mixture model refers to the mixture distribution that represents the probability distribution of observations in the overall population. However, while problems associated with “mixture distributions” relate to deriving the properties of the overall population from those of the sub-populations, “mixture models” are leveraged to make statistical inferences about the properties of the sub-populations given only observations on the pooled population, without sub-population identity information. A Gaussian mixture model corresponds to a probabilistic model that assumes all the data points are generated from a mixture of a finite number of Gaussian distributions with unknown parameters. At a high level, mixture models can be described as generalizing k-means clustering to incorporate information about the covariance structure of the data as well as the centers of the latent Gaussians.

Latent semantic analysis (LSA) is a technique in the field of natural language processing, in particular distributional semantics, of analyzing relationships between a set of documents and the terms they contain by producing a set of concepts related to the documents and terms. LSA relies on the assumption that words that are close in meaning will occur in similar pieces of text (the distributional hypothesis). A matrix containing word counts per document (rows represent unique words and columns represent each document) is generated from a large piece of text and a mathematical technique called singular value decomposition (SVD) is utilized to reduce the number of rows while preserving the similarity structure among columns. Documents are then compared by determining the cosine of the angle between the two vectors (or the dot product between the normalizations of the two vectors) formed by any two columns. Values close to 1 corresponds to very similar documents while values close to 0 represent very dissimilar documents.

A document-term matrix refers to a mathematical matrix which describes the frequency of terms that occur in a collection of documents. In a typical document-term matrix, rows correspond to documents in the collection of documents and columns correspond to terms within those documents. This type of matrix is a specific instance of a document-feature matrix where “features” may describe other properties of a document besides terms. The transpose of the document-term matrix (known as a term-document matrix) is also commonly encountered, where documents are the columns and terms are the rows. They are frequently useful in the fields of natural language processing and computational text analysis.

An integer programming problem refers to a mathematical optimization or feasibility program where at least some or all the variables are restricted to be integers. In various settings the term corresponds to integer linear programming (ILP), in which the objective function and the constraints (other than the integer constraints) are linear.

Pair programming is an agile software development technique where two programmers work together at a single workstation. One, the driver, writes code on the workstation while the other, the observer or navigator, reviews each line of code live as it is typed in by the driver. The two programmers frequently alternate roles.

### SUMMARY

According to an aspect of the present invention, there is a method, computer program product and/or system that performs the following operations (not necessarily in the following order): (i) receiving an incident triage training input dataset corresponding to a plurality of historical technical incidences; (ii) generating an incident triage machine learning model based, at least in part, on the incident triage training input dataset; (iii) receiving a new technical incident dataset corresponding to a technical incident for triage; (iv) determining a technical incident triage response corresponding to the technical incident for triage in the new technical incident dataset, where the incident triage response includes determining a triage responder from a plurality of triage responders within an organization; and (v) outputting the triage response to the determined triage responder.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a flowchart showing a second embodiment method;

FIG. 6 is a block diagram showing a second embodiment of a system according to the present invention; and

FIG. 7 is a block diagram showing a second machine learning model according to the second embodiment method.

### DETAILED DESCRIPTION

Some embodiments of the present invention are directed to techniques for training and utilizing a machine learning model for automatically accelerating technical incident triage. A historical dataset is combined from a plurality of sources corresponding to historical technical incidences and how they were resolved, including what persons or responders were involved in responding to the incident. This historical dataset is processed for input into a machine learning model which is trained to output a ranking of historical incidences based on similarity to an input incident. Machine logic then automatically selects a responder for the incident based on which available responders previously resolved the ranked historical incidences, selecting responders from the most similar historical incidences if they are available, and communicating information from the ranked historical incidences to assist in diagnosing and resolving the input incident.

This Detailed Description section is divided into the following subsections: (i) The Hardware and Software Environment; (ii) Example Embodiment; (iii) Further Comments and/or Embodiments; and (iv) Definitions.

### I. the Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium sometimes referred to as a machine readable storage device, can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be any thing made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer’s non-volatile storage and partially stored in a set of semiconductor switches in the computer’s volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

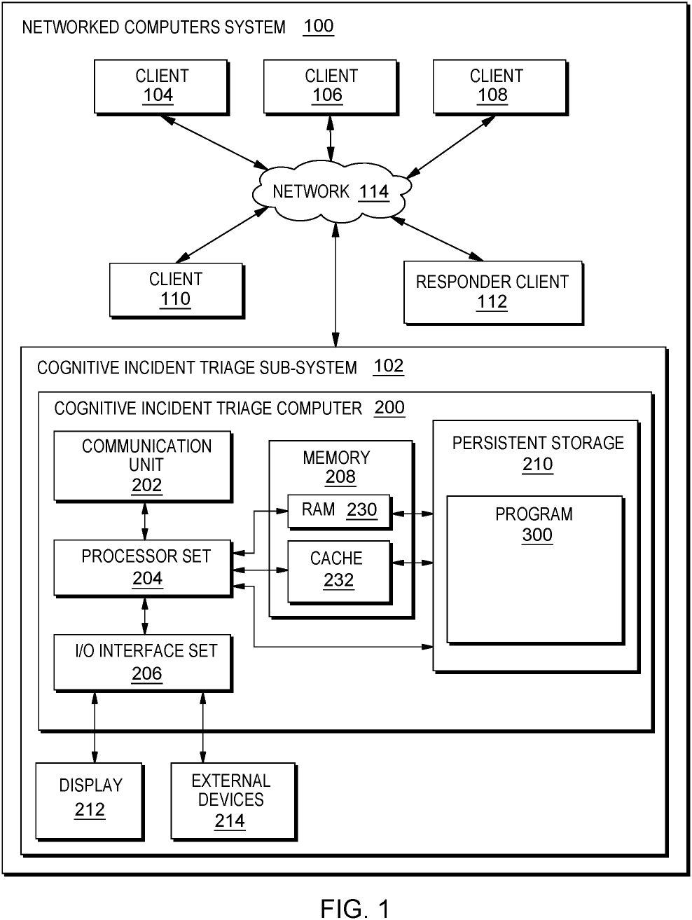

As shown in FIG. 1, networked computers system 100 is an embodiment of a hardware and software environment for use with various embodiments of the present invention. Networked computers system 100 includes: cognitive incident triage subsystem 102 (sometimes herein referred to, more simply, as subsystem 102); client subsystems 104, 106, 108, 110; responder client 112; and communication network 114. Subsystem 102 includes: cognitive incident triage computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device(s) 214. External device(s) 214 will typically include devices such as a keyboard, keypad, a touch screen, and/or some other suitable input device. External device(s) 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

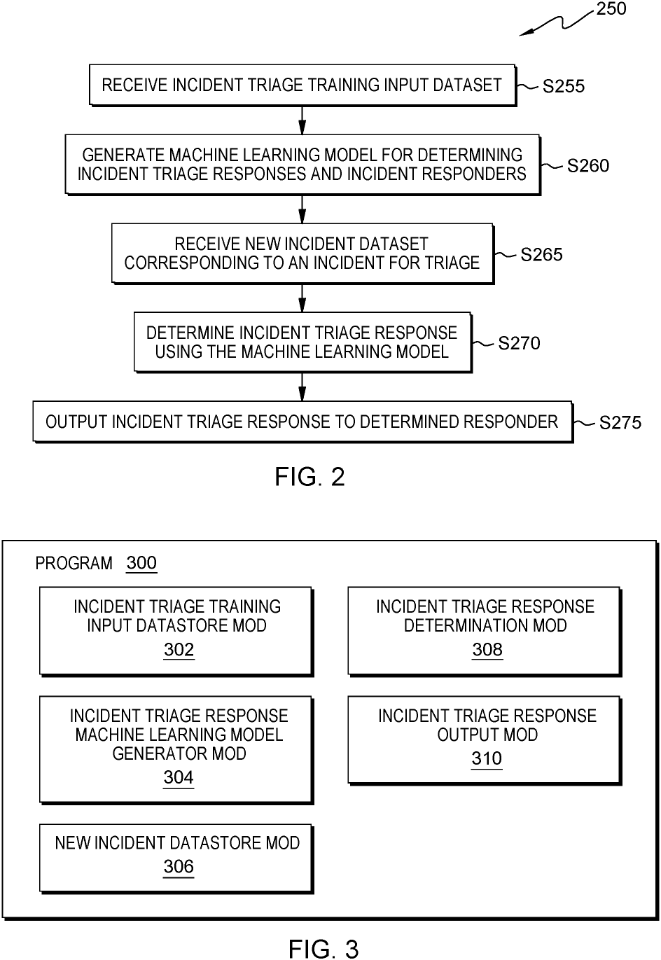

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

Processing begins at operation S255, where incident triage training input datastore module (“mod”) 302 receives an incident triage training input dataset. In this simplified embodiment, the incident triage training input dataset includes a plurality of historical incidences, with each historical incident including the following attributes and their corresponding values: (i) incident identification number (for example, incident_12345; (ii) system symptoms corresponding to the incident (for example, connection timeout, resource not found); (iii) technology stack of the system (for example, WAS Liberty/Kafka/Redis/MQ/DB2/Mongo DB/Datapower/MobileFirst); (iv) health data of the system (for example memory usage, processing capacity, null pointer exception, connection pool, resource pool, infrastructure health, number of waiting threads, heap size full, stack overflow etc.); (v) root cause analysis description of the incident (for example, JDBC driver default timer level configuration causing hung threads in WebSphere App Server); (vi) what the corresponding fix was for the incident (Update default timer level in JDBC driver as per number of data retrieval estimates defined in Application Data Architecture); and (viii) incident responder(s) who contributed to resolving the incident (for example, developer_1). The historical incidences are sourced from a plurality of sources, such as clients 104, 106 and 108.

Processing proceeds to operation S260, where incident triage response machine learning model generator mod 304 generates a machine learning model for determining incident triage responses and incident responders. In this simplified embodiment, generating the machine learning model for determining incident triage responses and incident responders begins with applying latent semantic indexing to process the contents of each incident in the incident triage training input dataset to identify keywords that appear throughout the dataset and statistical co-occurrences of words that appear together. The model is then trained on the processed contents to generate cosine similarity values between an input incident and the historical incidences, ranked in order of most similar to least similar, with each historical incident having one or more responders who responded to the historical incident to resolve it along with a RCA description and what measures were taken to resolve the incident. A responder may be an engineer or other type of person tasked with resolving problems in applications and systems supported by the embodiments of the present invention. The machine learning model, ranking the historical incidences from most similar to least similar, the model determines (without any direct human intervention): (i) what is most likely causing the present problem, via the RCA of similar historical incidences; (ii) what the most likely solution to the present incident is; and (iii) what responders have previous experience resolving the most similar problems.

Processing proceeds to operation S265, where new incident datastore mod 306 receives a new incident dataset corresponding to an incident for triage. In this simplified embodiment, the new incident dataset, received from client 110, includes the following attributes and their corresponding values: (i) incident identification number (in this example, incident_20); (ii) system symptoms corresponding to the incident; (iii) technology stack of the system; and (iv) health data of the system.

Processing proceeds to operation S270, where incident triage response determination mod 308 determines an incident triage response using the machine learning model. In this simplified embodiment, latent semantic processing is applied to the attribute values for the new incident dataset and then the machine learning model trained at S260 determines a ranking of cosine similarity values for each historical incident that has been previously analyzed by the embodiment. Each attribute that is inputted into the machine learning model provides greater context for determining which historical incident was most similar to the incident in the new incident dataset, and thus which historical incident: (i) most likely shares the same RCA; (ii) most likely has the same solution; and (iii) which responders have experience resolving historical incidences that are most similar to the incident in the new incident dataset. In this simplified embodiment, the machine learning model determined that a historical incident (incident identification number incident_7) has a cosine similarity score of 0.99, which is the highest out of the historical incidences previously analyzed by the present embodiment. For identification number incident_7, the root cause analysis description is “Mobile First platform database very high response time” and the corresponding resolution is “Requires Heap Size limit updates on Mobile First database main and replica instances,” and Developer_15 applied the resolution on a pair programming team with Developer_16.

Incident triage response determination mod 308 then determines if Developer_15 is available to respond to the incident in the new incident dataset. This can be achieved in a number of ways, such as querying a task assignment system to see if Developer_15 is currently assigned one or more tasks, or if they have any availability for another assignment. If Developer_15 is available, incident triage response determination mod 308 determines them to be the best responder to respond to the incident in the new incident dataset. If Developer_15 is unavailable, incident triage response determination mod 308 next looks to any pair programming responders, such as Developer_16, to see if they are available. As a pair programmer with Developer_15 on resolving incident_7, Developer_16 has a similar amount of experience to Developer_15 on resolving incident_7. If any pair programmers are not available from the most similar historical incident based on cosine similarity, incident triage response determination mod 308 proceeds to the next most similar historical incident to check for availability of their corresponding responders. In this simplified embodiment, Developer_15 is unavailable, which results in incident triage response determination mod 308 determining Developer_16 to resolve the incident in the new incident dataset, with the determination based on Developer_16′s experience as the pair programmer alongside Developer_15 in resolving incident_7.

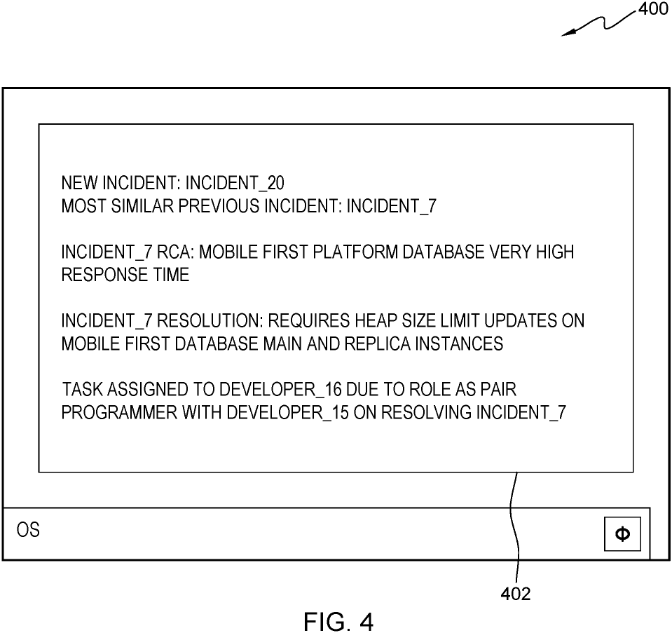

Processing proceeds to operation S275, where incident triage response output mod 310 outputs an incident triage response to a determined responder. In this simplified embodiment, Developer_16 has been determined to be the responder to the incident in the new incident dataset, with the most similar RCA of “Mobile First platform database very high response time” and the corresponding resolution of “Requires Heap Size limit updates on Mobile First database main and replica instances” outputted as a message to a computer device that is accessible by Developer_16, as shown in message 402 of screenshot 400 of FIG. 4.

In some alternative embodiments, instead of triaging, embodiments based on diagnosing and/or diagnostics are executed. In these alternative embodiments, diagnosing a technical problem corresponds to the process of establishing the exact cause of the technical incident. Diagnose operations will clearly tell what the problem is and indicate in turn what can be a quick fix (for example, “JVM Memory full” can be the outcome of diagnosis,) whereas which application code is causing the memory to be full or causing a memory leak would correspond to RCA. Another way to look at it is diagnosis is done in immediately in few hours whereas RCA may take few days.

### III. Further Comments and/or Embodiments

Some embodiments of the present invention recognize the following facts, potential problems and/or potential areas for improvement with respect to the current state of the art: (i) Incidents and defects are integral part of the cloud administration and software development life cycle; (ii) Although required capacity planning, precautions, every measure, and care are taken to architect the high availability systems and functionality, robust design, best of technology stack is chosen, the incidents occur; (iii) However, if the incidents in the critical applications take longer duration to fix, this in turn might cause service line level agreements breach, financial loss, site/service unavailability, lack of confidence, dissatisfied clients; (iv) Incidents also cause the urgency to fix, escalations, panic and stress among stakeholders; (v) The longer is the duration of the incident, the more is the damage to the brand value; (vi) The enterprise adopts many systems and methods to manage the incidents; (vii) However, there is no method and system available to accelerate the defect triage process by following an end to end framework of incident resolution, accelerate; (viii) There currently is no method and system which takes into consideration symptoms of the system in context, health data of the system, system technology stack, the functionalities of the application, the input from subject matter experts to derive probable root cause of the incident; and (ix) There currently is no method and system utilizing the AI model to assign the right team member to fix the incident.

Some embodiments of the present invention may include one, or more, of the following operations, features, characteristics and/or advantages: (i) an end to end framework for accelerating the defect triage process, finding the root cause of the incident, incident resolution and optimizing the incident lifecycle process; (ii) taking the symptoms of the site/system in context (for example, connection timeout, resource not found, very high response time, intermittent delay etc.), health data (for example memory usage, processing capacity, null pointer exception, connection pool, resource pool, infrastructure health, heap size full etc.), system technology stack, the functionalities of the application, the input from subject matter experts into consideration; (iii) The normalized data is saved in an inventory; (iv) When an incident occurs, the AI model performs co-relation and identifies the closer incident from the inventory; (v) The AI model in the framework suggests the most probable root cause analysis (RCA) and also the right skilled team member to fix the incident.

Some embodiments of the present invention may include one, or more, of the following operations, features, characteristics and/or advantages: (i) help in identifying the root cause of the incident and also the right team member to fix the incident in an optimized manner; (ii) an end to end framework by taking into consideration multiple parameters fueled by mathematical algorithms and provides recommendation policy to identify most probable RCA, resolution of the incident and also the next best team member to fix the incident; (iii) identifying the right team member to resolve the defect based on experience, matching skill of the resources if the prior team member who had fixed the defect is no longer available; (iv) providing the resolution with the confidence level; (v) create a holistic recommendation policy of identifying the root cause, resolution of the incident and selecting right subject matter expert, team member to fix the incident in an optimized manner; (vi) consider various site reliability parameters of the system in context, infrastructure health, software stack, subject matter input, lexical analysis which is customized to client project environment to derive the probable root cause of the incident; (vii) latent semantic indexing would find best matching tickets to existing tickets and arrange in cosine similarities; (viii) developer skill matrix matching feasibility based on who has worked on the incident; (ix) if the same team member is occupied, then who is the next best person to work on it, who was either part of pair programming with the subject matter expert or the same skill set match using principal component analysis, clustering/gaussian mixture model; (x) perform optimized team member identification among a set of team members to accelerate the incident fix time based on integer programming; (xi) accelerate the defect triage process; (xii) recommendation to prevent near future incident by performing the analytics of the system parameters; and (xii) for instance, if the query execution is taking longer durations intermittently, the framework sends a notification to the stakeholders.

Some embodiments of the present invention may include one, or more, of the following operations, features, characteristics and/or advantages: (i) Step 1 – Data Collection and Integration; (ii) at step 1.1, gather large datasets (Issue, Issue type – technical, functional, environment, severity, priority, technology stack, corresponding root cause analysis, resolution, time taken to fix the defect, subject matter expert who provided the fix) from several incident systems; (iii) both structured and unstructured data will be integrated to form the dataset; (iv) gather the symptoms of the system in context (for example, connection timeout, resource not found, very high response time, intermittent delay etc.); (iv) gather health data of the system (for example memory usage, processing capacity, null pointer exception, connection pool, resource pool, infrastructure health, number of waiting threads, heap size full, stack overflow etc.); (v) gather system technology stack; (vi) gather the functionalities of the application; (vii) gather the input from subject matter experts; (viii) leverage Latent Semantic Indexing (LSI) to analyze the set of incident description and discovers statistical co-occurrences of words that appear together and provides insights of those words; (ix) create a dictionary of the key words from the defect list; (x) each word /phrase may be in multiple defects; (xi) hence creation of a matrix using term document framework; (xii) create principal component analysis to reduce the number of dimensions; (xiii) when a new incident occurs, find best matching incidents to existing incidents and arrange in cosine similarities; (xiv) at step 2, analyze the dataset, learn and enhance AI Model; (xv) once a lexical analysis has been determined, identify the right team member to resolve the issue; (xvi) the model recommends the right team member who can fix the incident with minimal time with the confidence level; (xvii) if the team member is unavailable, the next best team member to fix the issue is identified (and so on, based on availability of team members); (xviii) at step 3, admin and data management is performed; and (xix) the new incident cognitively becomes part of the data set for future usage in the model.

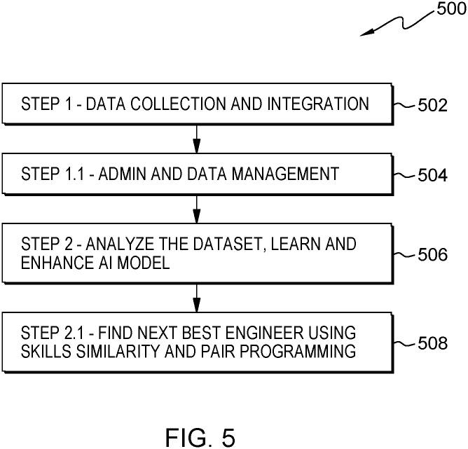

A second embodiment method of the present invention will now be discussed as shown in flowchart 500 of FIG. 5 which includes the following steps: (i) step 1 – data collection and integration 502; (ii) step 1.1 – admin and data management 504; (iii) step 2 – analyze the data set, learn and enhance ai model 506; and (iv) step 2.1 – find next best engineer using skills similarity and pair programming 508.

According to this second embodiment method, at Step 1 – Data Collection and Integration 502, there are diverse sources of data for the incidents, defects, tickets. Few sources contain normalized structured data and few sources contain unstructured data. The data needs to be gathered from various sources and integrated to form the master dataset. The incident attributes can be title, description, severity, date of defect raised, detected by tester details, business impact priority, service level agreement etc. The root cause analysis and fix of the corresponding incident is captured. The symptoms of the system, the health data, various technology stack is collected. The cumulative data is saved in an inventory.

According to this second embodiment method, at Step 1.1 – Admin and Data Management 504, the new incident becomes part of the master incident dataset for future usage. The data can be segregated into multiple classes based on various criteria, e.g. domain (insurance, banking, health, utility, telecom etc.), based on technology stack, type of defects (infrastructure, functionality, technical coding, design) for easy access and management of the dataset.

According to this second embodiment method, at Step 2 – Analyze the Dataset, Learn and Enhance model 506 to Provide confidence score of test defect. The dataset is analyzed, and the AI based model learns from the dataset. When a new incident is raised, the keywords of the defect are matched with another incident or a combination of incidents. The context of the newly raised incident is matched with the incidents in the dataset. Latent Semantic Indexing would find best matching Tickets to existing Tickets and arrange in Cosine Similarities. If incident is re-opened after it was closed or multiple times, perform root cause of the incident by semantic analysis. The example of key words is: (i) environment (Prod, UAT, Integration, Development, Test); (ii) component (Microservice, portal UI, ETL – Extract, Transform, Load, Database, Middleware); (iii) functionality (domain - insurance, banking, telecommunication etc.); (iv) sub-functionality (underwriting, enrolment, billing, claim); (v) technology stack (spring boot, java, react js); (vi) severity (critical, high, medium, low); (vii) priority (critical, high, medium, low); (viii) root cause; (ix) resolution; (x) time to resolve; and (xi) issue resolved

Mathematical Construct Let xₖ be vector of words which is introduced by new defect. Since xₖ can be the word frequency count of the defect. Leveraging word frequency count create Term Frequency Documentation of key words. Term Frequency (or TF(w)) is defined by the following formula:

$$\begin{matrix}T F \left(w\right) = \\ \frac{\begin{matrix}N u m b e r o f t i m e s a k e y w o r d o c c u r s i n d o c u m e n t a f t e r \\ L e m m a t i z a t i o n a n d S t e p W o r d s R e m o v a l i n T e s t D e f e c t\end{matrix}}{T o t a l N u m b e r o f w o r d s i n T e s t D e f e c t}\end{matrix}$$

IDF is defined by the following formula:

$$I D F = \frac{L o g \left(N u m b e r o f T e s t C a s e s\right)}{N u m b e r o f T e s t c a s e s c o n t a i n i n g w o r d w}$$

Then a weight (w,d) is determined based on the following formula:

$$w e i g h t \left(w , d\right) = T F \left(ω , d\right) ∗ I D F \left(ω\right)$$

Let X ∈ R^{m*n} where m is the number of test cases in the document and n be the number of key words in document. Let x_{iJ} denotes the word matrix for Iₜₕ case and jₜₕ word weight. Then find the cosine similarity between test cases as:

$$c o s \left(θ\right) ; C o n f i d e n c e S c o r e = \frac{x i ∗ x j}{{\left‖{x}_{i}\right‖}_{2} {\left‖{x}_{J}\right‖}_{2}}$$

The cosine Similarity provides the confidence score. Hence when a new test case comes in, compare the cosine similarity between all test cases and create a matrix of test case cosine factors in increasing order.

Model 2 – In case of Quick analysis, other alternative embodiments also use Singular Vector Decomposition which also serves as Latent Semantic Indexing for the test case Document. Test Case which has first 3 similar test cases are selected by increasing order of cosine similarity for similar test defects. Principal Component analysis can be arrived through Singular Vector Decomposition if the initial Matrix is normalized:

$$\begin{matrix}A = U ∗ Σ ∗ {V}^{T} \\ w h e r e C o v a r i a n c e M a t r i x M = {A}^{T} A \\ a n d M i s M a t r i x i s s q u a r e\end{matrix}$$

U, V are m×r and r*n matrices with orthonormal columns. The columns of V are called the right singular vectors of A while columns of U are called the left singular vectors of A and columns of A are the eigenvectors of the n×n matrix A^T A that correspond to its non-zero eigenvalues. The diagonal elements of matrix are called the singular values of A and are the non-negative square roots of the (common) non-zero eigenvalues of both matrix M^{T} M and matrix M^{T} M. Next, tune the number of Principal components to preserve the information as per equation below:

$${λ}_{i} = {Σ}_{i i}^{2}$$

Or:

$$\sqrt{e i g \left({A}^{T} A\right)} = S V D \left(A\right) = Σ$$

Now information contained in the Singular Vector Component is U * Σ. If there are i major singular vectors then new information A′ is defined by the following equation:

$${A}^{′} i s = U \left[M ∗ i\right] ∗ Σ \left(i ∗ i\right)$$

Next find the nearest Vector in A′ which is nearest to the test Case. V^{T} is r * p matrix which serves as eigenvectors or principal components. The nearest vector in terms of cosine similarity will provide confidence score of test defect.

According to this second embodiment method, at Step 2.1 - Best test Engineer to solve the issue using Pair programming 508, analyze the existing defect and see if the same team member is available. In case they are not available, use the next best (available) person to solve the defect.

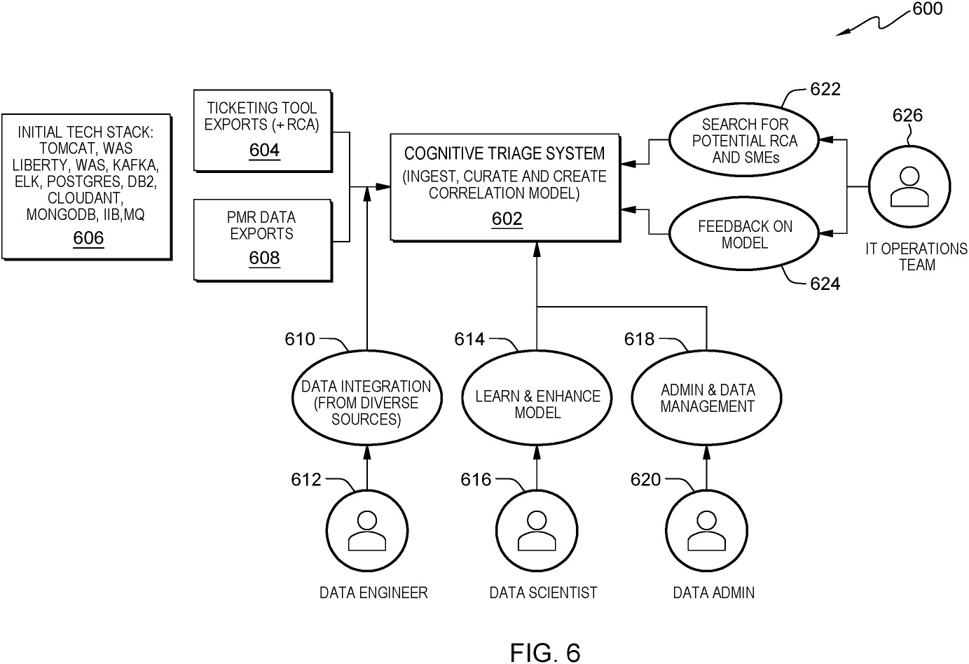

Diagram 600 of FIG. 6 shows a second embodiment system of a cognitive triage system according to the present invention, including: (i) cognitive triage system 602; (ii) ticketing tool exports 604; (iii) initial tech stack 606; (iv) PMR data exports 608; (v) data integration 610; (vi) data engineer 612; (vii) learn & enhance model 614; (viii) data scientist 616; (ix) admin & data management 618; (x) data admin 620; (xi) search for potential RCA 622; (xii) feedback on model 624; and (xiii) IT operations team 626.

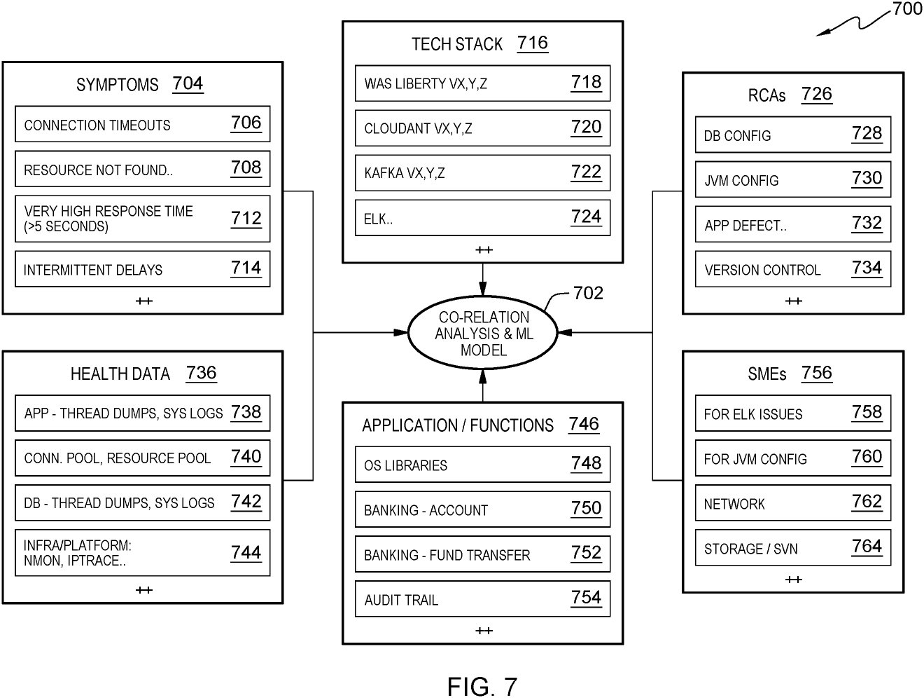

Diagram 700 of FIG. 7 shows a second machine learning model according to the second embodiment method, including: (i) co-relation analysis & ML model 702; (ii) symptoms 704, further including: (a) connection timeouts 706, (b) resource not found 708, (c) very high response time 712, and (d) intermittent delays 714; (iii) tech stack 716, further including: (a) WAS liberty 718, (b) Cloudant 720, (c) Kafka 722, and (d) ELK 724; (iv) RCAs 726, further including: (a) database (DB) config 728, (b) JVM Config 730, (c) APP defect 732, and (d) version control 734; (v) health data 736, further including: (a) app 738, (b) conn. pool, resource pool 740, (c) DB 742, and (d) infra/platform 744; (vi) applications/functions 746, further including: (a) OS libraries 748, (b) banking-account 750, (c) banking - fund transfer 752, and (d) audit trail 754; and (vii) SMEs 756, further including: (a) ELK issues 758, (b) JVM config 760, (c) network 762, and (d) storage / SVN 764.

Below are three sample input incidents with parameters and corresponding values for input to a machine learning model for cognitive incident triage according to some embodiments of the present invention, formatted into tables:

| Sample Input Parameters | Sample Values |
|---|---|
| Incident 1 | |
| Incident ID | CIT_YONO_EC2_RDS13 |
| Incident Type | Technical/Functional/Environment |
| Severity | Critical/High/Low |
| Technology Stack | WAS Liberty/Kafka/Redis/MQ/DB2/Mongo DB/Datapower/MobileFirst |
| Root Cause | JDBC driver default timer level configuration causing hung threads in WebSphere App Server |
| Resolution | Update default timer level in JDBC driver as per number of data retrieval estimates defined in Application Data Architecture |
| Time To Resolve | 65 hours |
| Issue Resolved by | Developer 1 |
| Incident 2 | |
| Incident ID | CIT_Mobile_YONO_EC214 |
| Incident Type | Technical/Functional/Environment |
| Severity | Critical/High/Low |
| Technology Stack | WAS Liberty/Kafka/Redis/MQ/DB2/Mongo DB/Datapower/MobileFirst |
| Root Cause | Mobile First platform database very high response time |
| Resolution | Requires Heap Size limit updates on Mobile First database main and replica instances |
| Time To Resolve | 90 hours |
| Issue Resolved by | Developer 1 |
| Incident 3 | |
| Incident ID | CIT_YONO_EC2_RDS17 |
| Incident Type | Technical/Functional/Environment |
| Severity | Critical/High/Low |
| Technology Stack | WAS Liberty/Kafka/Redis/MQ/DB2/Mongo DB/Datapower/MobileFirst |
| Root Cause | Kafka leader node not failing over in case of HW failure |
| Resolution | Requires a fail over node setup for Kafka leader node |
| Time To Resolve | 72 hours |
| Issue Resolved by | Developer 2 |

Below are two sample output sets with corresponding values outputted from a machine learning model for cognitive incident triage according to some embodiments of the present invention, formatted into tables:

| Sample Output | Sample Values |
|---|---|
| Output 1 | |
| Confidence Level Range | 0.75-0.95 |
| Root Cause Analysis | JDBC driver default timer level configuration causing hung threads in WebSphere App Server |
| Proposed resolution | Requires Heap Size limit updates on Mobile First database main and replica instances |
| Next best owner | Developer 1 (as he resolved both Incident 1, 2) |
| Output 2 | |
| Confidence Level Range | 0.5-0.75 |
| Root Cause Analysis | Kafka leader node not failing over in case of HW failure |
| Proposed resolution | Requires a fail over node setup for Kafka leader node |
| Next best owner | Developer 2 (as he resolved Incident 3) |

Below is a sample of defects, their parameters, and corresponding values for input into a machine learning model for incident triage according to some embodiments of the present invention, formatted as a table:

| Description | Severity | Affects Version/s | Assigned to | RCA | Resolution |
|---|---|---|---|---|---|
| Getting intermittent 502 - proxy server error for the micro service call. | High | 2020-08 | AppOps | One of the IIB node servers is down. When the service call is passing through the down IIB node server, the service call fails. When the service call is passing through the up IIB node server, the service call succeeds. | Bring up the IIB node server which is down |
| The service call is failing which is causing the SIC service functionality not to work | High | 2020-08 | AppOps | The microservice layer is passing special symbols (‘, &, space) in the query parameter to datapower. The datapower is performing incorrect translation by adding %% symbol before sending to third party service provider. This is causing the third party service unable to interpret the query parameter and in terms, the service is failing. | Change the datapower mapping for the special characters before sending the service to third party service provider. |
| The enrollment functionality is not working in portal | High | 2020-08 | AppOps | After checking, the components are functioning as expected. However, the container is stale although the container status is active. | Restart the container for enrollment service. |
| Unable to display claim details in the portal | High | 2020-08 | AppOps | The configuration for the DB connection was copied from UAT environment to Perf environment as it is. The IP address and port for the PERF DB connection was not specified. This led to unable to connect to the DB driver. | The environment specific configuration file was connected. |
| The file is not uploaded successfully in portal | High | 2020-10 | Developer1 | The template was missing field. The effective date field was missing. The system was looking for the effective date field. As this field was not found, the file upload was failing. | The template was corrected before upload. |
| Premium is incorrectly being displayed in the portal | High | 2020-10 | Developer2 | The rate for premium calculation was incorrectly coming from the policy administration system. | The rate was corrected in the policy administration system. |
| Unable to generate the policy amendment document after the coverage amount is changed | High | 2020-10 | Developer3 | The document generation system was down as the fix pack patch was being applied in the system. | The transaction was retried after the patch was applied. |
| The pop-up screen was still present even after clicking “Cancel” button. | High | 2020-10 | Developer1 | A code fix was needed to handle this scenario. | Code fix was done by the developer |
| Unable to switch roles in the organization. | High | 2020-10 | Developer2 | A code fix was needed to handle this scenario. However, after the code fix, this needs to be tested with new data as extra fields were being added in the response payload. | The transaction was performed in new data instead of in the old data before the fix was applied. |
| The coverage start date is being displayed as incorrect in the portal | High | 2020-10 | Developer3 | The waiting period was not added with the group policy effective date while displaying the coverage start date. | Code fix was done by the developer |

Some embodiments of the present invention may include one, or more, of the following operations, features, characteristics and/or advantages: (i) propose to create a holistic recommendation policy of identifying the root cause, resolution of the incident and selecting right subject matter expert, team member to fix the incident in an optimized manner; (ii) consider various site reliability parameters of the system in context, infrastructure health, software stack, subject matter input, lexical analysis which is customized to Client Project environment to derive the probable root cause of the incident; (iii) Latent Semantic Indexing would find best matching Tickets to existing Tickets and arrange in Cosine Similarities; (iv) Developer Skill Matrix Matching feasibility based on who has worked on the incident, if the same team member is occupied, then who is the next best person to work on it, who was either part of pair programming with the subject matter expert or the same skill set match using Principal Component Analysis, Clustering/Gaussian Mixture Model; (v) Perform Optimized team member identification among a set of team members to accelerate the incident fix time based on Integer Programming; (vi) Accelerate the defect triage process; (vii) Recommendation to prevent near future incident by performing the analytics of the system parameters; (viii) For instance, if the query execution is taking longer duration intermittently, the framework sends a notification to the stakeholders.

Some embodiments of the present invention may include one, or more, of the following operations, features, characteristics and/or advantages: (i) end to end framework taking into consideration multiple parameters fueled by mathematical algorithms; (ii) provides recommendation policy to identify most probable RCA with probability accuracy percentage, resolution of the incident and also the next best team member to fix the incident; (iii) End-to-end framework for solutions and considers various site reliability parameters of the system in context such as (a) infrastructure health, (b) software stack, (c) subject matter input, and (d) lexical analysis which are customized to Client Project environment to derive the probable root cause of the incident; (iv) takes into consideration the symptoms of the site/system in context; (v) for example: (a) connection timeout, (b) resource not found, (d) very high response time, (e) intermittent delay, (f) health data (for example memory usage, processing capacity, null pointer exception, connection pool, resource pool, infrastructure health, heap size full etc.), (g) system technology stack, (h) the functionalities of the application, and (i) the input from subject matter experts; (vi) Latent Semantic Indexing would find best matching Tickets to existing Tickets and arrange in Cosine Similarities; (vii) an example of key words is: (a) environment (Prod, UAT, Integration, Development, Test), (b) component (Microservice, portal UI, ETL - Extract, Transform, Load, Database, Middleware), (c) functionality (domain - insurance, banking, telecommunication etc.), (d) sub-functionality (underwriting, enrolment, billing, claim), (e) technology stack (spring boot, java, react js), (f) severity (critical, high, medium, low), (g) priority (critical, high, medium, low), (h) root cause, (i) resolution, (j) time to resolve, and (k) issue resolved; (viii) Developer Skill Matrix Matching feasibility based on who has worked on the incident; (ix) if the same team member is occupied, then determine who is the next best person to work on it, who was either part of pair programming with the subject matter expert or the same skill set match using Principal Component Analysis, Clustering/Gaussian Mixture Model; (x) Perform Optimized team member identification among a set of team members to accelerate the incident fix time based on Integer Programming; and (xi) recommend the best team to resolve the problem using a novel pair programming approach.

Some embodiments of the present invention may include one, or more, of the following operations, features, characteristics and/or advantages: (i) root cause analysis using log file and provides early alarm about impending service outages and performance degrade); (ii) Recommendation to prevent near future incident by performing the analytics of the system parameters; (iii) For instance, if the query execution is taking longer duration intermittently, the framework notifies to the stakeholders; (iv) First of a kind model which optimizes /minimizes the mean time to resolution for the incidents given the custom client environment, find optimum resource-experience for incident resolution, leveraging various mathematical models; (v) a framework for accelerating the defect triage process; (v) to achieve this, this framework is used for finding the root cause of the incident, incident resolution, optimizing the incident lifecycle process, finding the best resource, next best resource (if best resource is unavailable) to resolve the incident, providing recommendation for probable future incidents; (vi) All the determinations are done by taking into consideration multiple parameters and by applying mathematical models such as Principal Component Analysis, Clustering/Gaussian Mixture Model, Latent Semantic Indexing, and Integer Programming.

Some embodiments of the present invention may include one, or more, of the following operations, features, characteristics and/or advantages: (i) uses machine learning & Optimization technique to find out the best resource, next best resource to expedite to solve the incident; (ii) This framework derives root cause and solution with accuracy probability; (iii) focuses on identifying the root cause; (iv) provides an end to end framework for accelerating the defect triage process, finding the root cause of the incident, incident resolution and optimizing the incident lifecycle process; (v) When an incident occurs, the AI model performs co-relation and identifies the closer incident from the inventory; (vi) The AI model in the framework suggests the most probable RCA and also the right skilled team member to fix the incident; (vii) takes into consideration multiple parameters for cognitive incident triage; (viii) The model takes into consideration multiple parameters; (ix) the parameters are as listed below but not limited to: (a) Type of Architecture (Traditional Data Ware House or Event Driven Hybrid Messaging), (b) connection timeout, (c) resource not found, (d) very high response time, (e) intermittent delay, (f) health data, (g) memory usage, (h) processing capacity, (i) null pointer exception, (j) connection pool, (k) resource pool, (1) infrastructure health, (m) heap size full, (n) system technology stack, (o) the functionalities of the application, and (p) the input from subject matter experts into consideration.

Some embodiments of the present invention may include one, or more, of the following operations, features, characteristics and/or advantages: (i) Latent Semantic Indexing would find best matching Tickets to existing Tickets and arrange based on Cosine Similarities; (ii) If incident is re-opened after it was closed or multiple times, perform root cause of the incident by semantic analysis; (iii) some examples of key words are: (a) environment (Prod, UAT, Integration, Development, Test), (b) component (Microservice, portal UI, ETL - Extract, Transform, Load, Database, Middleware), (c) functionality (domain - insurance, banking, telecommunication etc.), (d) sub-functionality (underwriting, enrolment, billing, claim), (e) technology stack (spring boot, java, react js), (f) severity (critical, high, medium, low), (g) priority (critical, high, medium, low), (h) root cause, (i) resolution, (j) time to resolve, and (k) issue resolved; (iv) provides end to end framework by taking into consideration multiple parameters fueled by mathematical algorithms and provides recommendation policy to identify: (a) most probable RCA, (b) resolution of the incident, and (c) the next best team member to fix the incident; (v) Along with process fault in a network environment, takes into consideration multiple parameters for cognitive incident triage; (vi) The model takes into consideration multiple parameters; and (vii) When an incident occurs, the AI model performs co-relation and identifies the closer incident from the inventory.

Some embodiments of the present invention may include one, or more, of the following operations, features, characteristics and/or advantages for leveraging pair programming in incident triage.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above - similar cautions apply to the term “embodiment.”

and/or: inclusive or; for example, A, B “and/or” C means that at least one of A or B or C is true and applicable.

In an Including / include / includes: unless otherwise explicitly noted, means “including but not necessarily limited to.”

Module / Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, and application-specific integrated circuit (ASIC) based devices.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

We: this document may use the word “we,” and this should be generally be understood, in most instances, as a pronoun style usage representing “machine logic of a computer system,” or the like; for example, “we processed the data” should be understood, unless context indicates otherwise, as “machine logic of a computer system processed the data”; unless context affirmatively indicates otherwise, “we,” as used herein, is typically not a reference to any specific human individuals or, indeed, and human individuals at all (but rather a computer system).

Triage (or alternatively, incident triage, technical incident triage): In the field of information technology (IT), triaging is the act of responding to sets of incidences (or problems, bugs, vulnerabilities, etc.) with a piece of technology (typically software, but could alternatively be firmware, hardware, or combinations thereof) in order to resolve the incident and restore the piece of technology to a desired state of operation, with the order in which incidences are responded to is based on: (i) economic impact of the incident (or IT problem); and (ii) length of time that the incident has been queued for a response/resolution. Economic impact of the incident may (but not necessarily) depend upon: (i) quality of service (QOS) terms of a service level agreement (SLA) between an entity providing the piece of technology (or the “provider”) and the entity receiving the piece of technology (or the “customer”); and (ii) economic significance of projects of the customer impacted by the incident, etc. Length of time that the incident has been queued for a response/resolution may (but not necessarily) depend upon: (i) urgency of the incident as indicated by the customer; (ii) time zone where the customer is located; and (iii) communication media used by the customer requesting a response to the incident, etc.

What is claimed is:

1. A computer-implemented method (CIM) comprising:
receiving an incident triage training input dataset corresponding to a plurality of historical technical incidences;
generating an incident triage machine learning model based, at least in part, on the incident triage training input dataset;
receiving a new technical incident dataset corresponding to a technical incident for triage;
determining a technical incident triage response corresponding to the technical incident for triage in the new technical incident dataset, where the incident triage response includes determining a triage responder from a plurality of triage responders within an organization; and
outputting the triage response to the determined triage responder.

2. The CIM of claim 1, wherein a given historical technical incidence in the plurality of historical technical incidences includes: system defect symptoms, system health data, technology stack, functionalities of applications deployed on a given system, and subject matter expert input, including identities of incident responders who responded to the given historical technical incidence.

3. The CIM of claim 1, wherein the incident triage machine learning model applies latent semantic indexing on the plurality of historical technical incidences and the new technical incident dataset.

4. The CIM of claim 3, wherein determining the technical incident triage response further includes:
determining a ranking of historical technical incidences based on cosine similarity scores from latent semantic indexing in order of most similar to least similar.

5. The CIM of claim 4, wherein determining a technical incident triage response further includes:
receiving an incident responder dataset corresponding to the plurality of triage responders within the organization, including information indicative of their availability to respond to technical incidences; and
determining a target incident responder for responding to the technical incident for triage in the new technical incident dataset based, at least in part, on the ranking of historical technical incidences and their corresponding incident responders, where incident responders who responded to historical technical incidences ranked most similar are preferred based on their availability to respond to technical incidences.

6. The CIM of claim 1, wherein the outputted triage response includes: (i) a root cause analysis description, (ii) a proposed resolution to the root cause analysis in the root cause analysis description, and (iii) identification information corresponding to an incident responder, including which incidents the incident responder previously responded to which contributed to the determination of the outputted triage response.

7. A computer program product (CPP) comprising:
a machine readable storage device; and
computer code stored on the machine readable storage device, with the computer code including instructions for causing a processor(s) set to perform operations including the following:
receiving an incident triage training input dataset corresponding to a plurality of historical technical incidences,
generating an incident triage machine learning model based, at least in part, on the incident triage training input dataset,
receiving a new technical incident dataset corresponding to a technical incident for triage,
determining a technical incident triage response corresponding to the technical incident for triage in the new technical incident dataset, where the incident triage response includes determining a triage responder from a plurality of triage responders within an organization, and
outputting the triage response to the determined triage responder.

8. The CPP of claim 7, wherein a given historical technical incidence in the plurality of historical technical incidences includes: system defect symptoms, system health data, technology stack, functionalities of applications deployed on a given system, and subject matter expert input, including identities of incident responders who responded to the given historical technical incidence.

9. The CPP of claim 7, wherein the incident triage machine learning model applies latent semantic indexing on the plurality of historical technical incidences and the new technical incident dataset.

10. The CPP of claim 9, wherein determining the technical incident triage response further includes:
determining a ranking of historical technical incidences based on cosine similarity scores from latent semantic indexing in order of most similar to least similar.

11. The CPP of claim 10, wherein determining a technical incident triage response further includes:
receiving an incident responder dataset corresponding to the plurality of triage responders within the organization, including information indicative of their availability to respond to technical incidences; and
determining a target incident responder for responding to the technical incident for triage in the new technical incident dataset based, at least in part, on the ranking of historical technical incidences and their corresponding incident responders, where incident responders who responded to historical technical incidences ranked most similar are preferred based on their availability to respond to technical incidences.

12. The CPP of claim 7, wherein the outputted triage response includes: (i) a root cause analysis description, (ii) a proposed resolution to the root cause analysis in the root cause analysis description, and (iii) identification information corresponding to an incident responder, including which incidents the incident responder previously responded to which contributed to the determination of the outputted triage response.

13. A computer system (CS) comprising:
a processor(s) set;
a machine readable storage device; and
computer code stored on the machine readable storage device, with the computer code including instructions for causing the processor(s) set to perform operations including the following:
receiving an incident triage training input dataset corresponding to a plurality of historical technical incidences,
generating an incident triage machine learning model based, at least in part, on the incident triage training input dataset,
receiving a new technical incident dataset corresponding to a technical incident for triage,
determining a technical incident triage response corresponding to the technical incident for triage in the new technical incident dataset, where the incident triage response includes determining a triage responder from a plurality of triage responders within an organization, and
outputting the triage response to the determined triage responder.

14. The CS of claim 13, wherein a given historical technical incidence in the plurality of historical technical incidences includes: system defect symptoms, system health data, technology stack, functionalities of applications deployed on a given system, and subject matter expert input, including identities of incident responders who responded to the given historical technical incidence.

15. The CS of claim 13, wherein the incident triage machine learning model applies latent semantic indexing on the plurality of historical technical incidences and the new technical incident dataset.

16. The CS of claim 15, wherein determining the technical incident triage response further includes:
determining a ranking of historical technical incidences based on cosine similarity scores from latent semantic indexing in order of most similar to least similar.

17. The CS of claim 13, wherein determining a technical incident triage response further includes:
receiving an incident responder dataset corresponding to the plurality of triage responders within the organization, including information indicative of their availability to respond to technical incidences; and
determining a target incident responder for responding to the technical incident for triage in the new technical incident dataset based, at least in part, on the ranking of historical technical incidences and their corresponding incident responders, where incident responders who responded to historical technical incidences ranked most similar are preferred based on their availability to respond to technical incidences.

18. The CS of claim 13, wherein the outputted triage response includes: (i) a root cause analysis description, (ii) a proposed resolution to the root cause analysis in the root cause analysis description, and (iii) identification information corresponding to an incident responder, including which incidents the incident responder previously responded to which contributed to the determination of the outputted triage response.
